(19) United States
(12) Patent Application Publication
(10) Pub. No.: US 2015/0203295 A1
(43) Pub. Date: Jul. 23, 2015

(54) TRANSFER DEVICE

(71) Applicant: MURATA MACHINERY, LTD., Kyoto-shi, Kyoto (JP)

(72) Inventor: Akitoshi Nakamura, Inuyama-shi (JP)

(73) Assignee: MURATA MACHINERY, LTD., Kyoto-shi, Kyoto (JP)

(21) Appl. No.: 14/424,591

(22) PCT Filed: Aug. 20, 2013
(86) PCT No.: PCT/JP2013/072179

§ 371 Date: Feb. 27, 2015

(30) Foreign Application Priority Data
Sep. 6, 2012 (JP) 2012-195967

(51) Int. Cl. B65G 1/04

(52) U.S. Cl. CPC B65G 1/0435; B65G 1/0421; B65G 1/0407

(57) ABSTRACT

A transfer device includes a slide arm, a first hook capable of moving to an action position protruding toward an article and to a retract position to avoid contact with the article, a first end detection sensor for configured to detect an end position of the article in the sliding direction of the slide arm, and a controller configured or programmed to allow the slide arm to start to move, to allow the first hook to start to move from the retract position to the action position when a distal end position of the article is detected, and to allow the slide arm to slide in the opposite direction after the first hook reaches a predetermined position.

### BACKGROUND OF THE INVENTION

1. Field of the Invention

The present invention relates to a transfer device configured to transfer an article in a stacker crane or a station of an automated transport system.

2. Description of the Related Art

A stacker crane includes a transfer device configured to transfer an article to and from a shelf disposed in an automatic warehouse. In addition, the station of the automated transport system is provided with the transfer device configured to transfer an article to and from a carrier.

As systems of the transfer device, there are a slide fork system in which the article is picked up and transferred by a fork, a suction system in which the article is sucked, held, and transferred, a pickup belt system in which the article is moved to slide and is transferred by a pickup belt, a clamp system in which the article is pinched and held at its both sides and is transferred, and a hook system in which an end of the article is engaged with a hook disposed on a tip of a slide arm so that the article is pushed or pulled and is transferred when the slide arm moves forward and backward.

For instance, there is proposed a transfer device provided with a hook supported in a rotatable manner on a tip of the slide arm (for example, see WO2011/158422).

In WO2011/158422, the hook disposed on the tip of the slide arm rotates with respect to the slide arm and hence can move between an action position for contacting with the end of the article and a retract position for not contacting with the article. In an action of pulling the article, this transfer device sets the hook in the retract position and moves the slide arm forward toward the article, and then moves the hook to the action position so as to engage with a distal end of the article, and finally retracts the slide arm so as to pull the article toward the transfer device.

As to the transfer device of the hook system described above, in order to securely engage the hook with the end of the article, the slide arm is moved forward so that the hook reaches a predetermined position over the distal end position of the article. The transfer device moves the slide arm so that the hook reaches the predetermined position and then moves the hook from the retract position to the action position. Further, the transfer device retracts the slide arm so that the hook engages with a rear end of the article, and hence the article is pulled into the transfer device.

In this way, the transfer device sequentially performs the step of moving the slide arm forward, the step of switching the hook position, and the step of retracting the slide arm. Therefore, the transfer device has a problem that the transfer process takes long time.

### SUMMARY OF THE INVENTION

Preferred embodiments of the present invention shorten a time required for the transfer process to be performed in the transfer device used for the stacker crane or the station of the automated transport system.

Hereinafter, a plurality of aspects of various preferred embodiments of the present invention will be described below. These aspects are capable of being arbitrarily combined as necessary or desired.

A transfer device according to an aspect of various preferred embodiments of the present invention includes a slide arm, an engagement member, an end detector, and a controller.

The slide arm is configured to slide relative to a placed article.

The engagement member is attached to the slide arm, so as to be capable of moving between an action position protruding toward the article in a direction crossing a sliding direction of the slide arm and a retract position to avoid contact with the article.

The end detector is attached to the slide arm to detect an end position of the article in the sliding direction of the slide arm.

The controller is configured or programmed to allow the engagement member to be placed in the retract position, to allow the slide arm to start to slide to a predetermined position where the engagement member moves over a distal end position of the article, to allow the engagement member to start to move from the retract position to the action position by determining that the engagement member has passed the distal end position of the article when the end detector detects the distal end position of the article, and to allow the slide arm to slide in the opposite direction after the engagement member reaches the predetermined position.

In this transfer device, the slide arm is moved to a predetermined position and afterwards is moved in the opposite direction in the state where the engagement member is moved to the action position. In this way, the article is pushed by the engagement member and is moved.

In this transfer device, the slide arm is moved to the predetermined position. In other words, the stroke is constant. Therefore, control of the slide arm becomes simple. In addition, because a condition to start to move the engagement member from the retract position to the action position is that the end detector detects the distal end position of the article, the action of setting the engagement member in the action position is performed while the slide arm is sliding. As a result, the transfer process time is shortened.

The end detector preferably is attached to the slide arm so as to be adjacent to the engagement member.

The slide arm preferably includes a pair of parallel arm portions positioned away from each other by a predetermined distance at positions capable of sliding on both sides of the article. In addition, the engagement member preferably includes a pair of engagement portions provided respectively in the pair of arm portions.

In this transfer device, because the slide arms and the engagement members are disposed on both sides of the article, power from the engagement member is applied to each side of the article. Therefore, a position of the article is maintained.

The end detector preferably includes a light emitter and a light receiver provided in the pair of arm portions.

The controller preferably is configured or programmed to store the distal end position of the article detected by the end detector when moving the slide arm until the engagement member reaches the predetermined position, and to move the slide arm slowly until the engagement member reaches the distal end position of the article at earliest when moving the slide arm to slide in the opposite direction.

In this transfer device, because the slide arm is moved at low speed until the engagement member reaches the end position of the article, an impact to the article is reduced. Further, because the slide arm is moved at high speed after that, the transfer process time is significantly shortened.

A transfer device according to another aspect of various preferred embodiments of the present invention includes a slide arm, a first engagement member and a second engagement member, a first end detector and a second end detector, and a controller.

The slide arm is configured to slide relative to a first article and a second article placed in series in a moving direction.

The first engagement member and the second engagement member preferably move synchronously with each other between an action position protruding toward the first article and the second article in a direction crossing a sliding direction of the slide arm and a retract position to avoid contact with the first article and the second article, and correspond respectively to the first article and the second article.

The first end detector and the second end detector are attached to the slide arm, so as to respectively detect end positions of the first article and the second article in the sliding direction of the slide arm.

The controller is configured or programmed to set the first engagement member and the second engagement member in the retract position, to allow the slide arm to start to slide until the first engagement member and the second engagement member respectively reach a first position and a second position over distal end positions of the first article and the second article, to allow the first engagement member and the second engagement member to start to move from the retract position to the action position by determining that the first engagement member and the second engagement member have respectively passed the distal end positions of the first article and the second article when the first end detector and the second end detector respectively detect the distal end positions of the first article and the second article, and to allow the slide arm to slide in the opposite direction after the first engagement member and the second engagement member respectively reach the first position and the second position.

According to various preferred embodiments of the present invention, the transfer process time is significantly shortened in the transfer device used for the stacker crane or the station of the automated transport system.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing a portion of an automatic warehouse provided with a stacker crane including a transfer device.

FIG. 2 is a side view showing schematically the automatic warehouse.

FIGS. 3A and 3B are explanatory diagrams of a transfer device 100 according to a first preferred embodiment of the present invention, wherein FIG. 3A is a plan view in the case where a hook is in a retract position, and FIG. 3B shows a side view thereof.

FIGS. 4A and 4B are explanatory diagrams of the transfer device 100 according to the first preferred embodiment of the present invention, wherein FIG. 4A shows a plan view in the case where the hook is in an action position, and FIG. 4B shows a side view thereof.

FIG. 5 is a control block diagram of the first preferred embodiment of the present invention.

FIG. 6 is a control flowchart of the first preferred embodiment of the present invention.

FIG. 7 is a timing chart when a slide arm 110 moves, wherein 7(A) shows a detection signal of a first end detection sensor 116, 7(B) shows a position of the slide arm 110, 7(C) shows movement speed of the slide arm 110, and 7(D) shows movement speed of a first hook 114.

FIG. 8 is a timing chart when the slide arm 110 moves in the opposite direction, 8(A) shows a detection signal of the first end detection sensor 116, 8(B) shows a position of the slide arm 110, and 8(C) shows movement speed of the slide arm 110.

FIG. 9 is an explanatory diagram of the transfer device 100 according to a second preferred embodiment of the present invention.

FIG. 10 is a control block diagram of the second preferred embodiment of the present invention.

FIG. 11 is a control flowchart of the second preferred embodiment of the present invention.

FIG. 12 is a timing chart when the slide arm 110 moves toward a shelf 302, wherein 12(A) shows the detection signal of the first end detection sensor 116, 12(B) shows the detection signal of a third end detection sensor 119, 12(C) shows a movement position of the slide arm 110, and 12(D) shows movement speed of the first hook 114 and a second hook 115.

FIG. 13 is a timing chart when the slide arm 110 slides from the shelf 302 toward an elevation table 316, wherein 13(A) shows the detection signal of the first end detection sensor 116, 13(B) shows detection signal of the third end detection sensor 119, 13(C) shows the position of the slide arm 110, and 13(D) shows movement speed of the slide arm 110.

### DETAILED DESCRIPTION OF THE PREFERRED EMBODIMENTS

As a preferred embodiment of a transfer device of the present invention, a case where a transfer device is disposed in a stacker crane is exemplified and described.

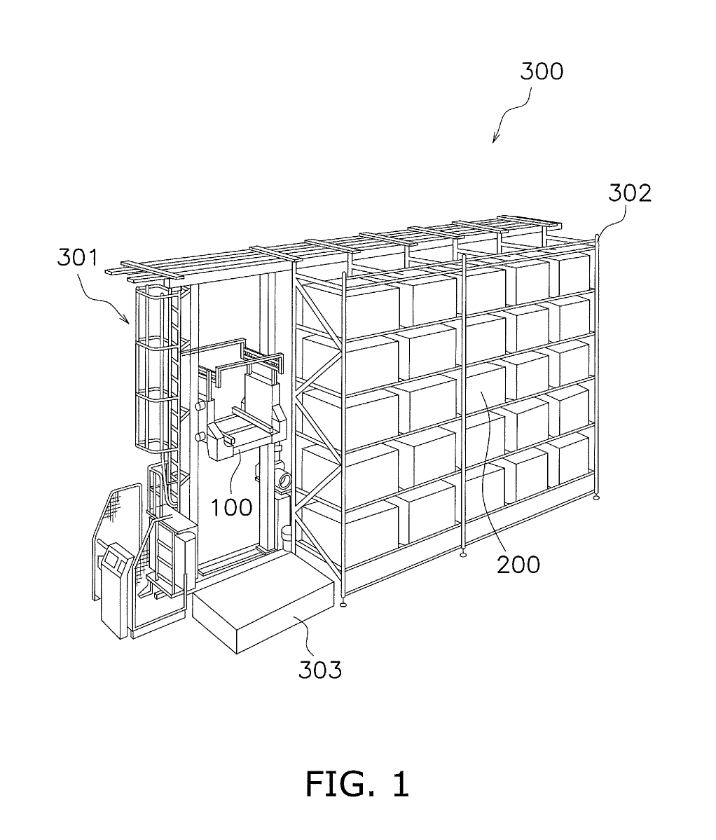

FIG. 1 is a perspective view showing a portion of an automatic warehouse provided with the stacker crane including the transfer device.

As shown in FIG. 1, an automatic warehouse 300 includes a stacker crane 301 capable of traveling to transport an article 200, and shelves 302 disposed on both sides of the traveling direction of the stacker crane 301.

The automatic warehouse 300 includes a station 303 configured to store and retrieve the article 200. The stacker crane 301 includes a transfer device 100. The stacker crane 301 transfers the article 200 transported onto the station 303 to the stacker crane 301 by the transfer device 100. In addition, the stacker crane 301 carries the article 200 onto a storage position on the shelf 302 and transfers the same to the corresponding shelf 302 by using the transfer device 100.

Similarly, the stacker crane 301 transfers the article 200 stored on the shelf 302 to the stacker crane 301 by using the transfer device 100 and carries the same to the station 303.

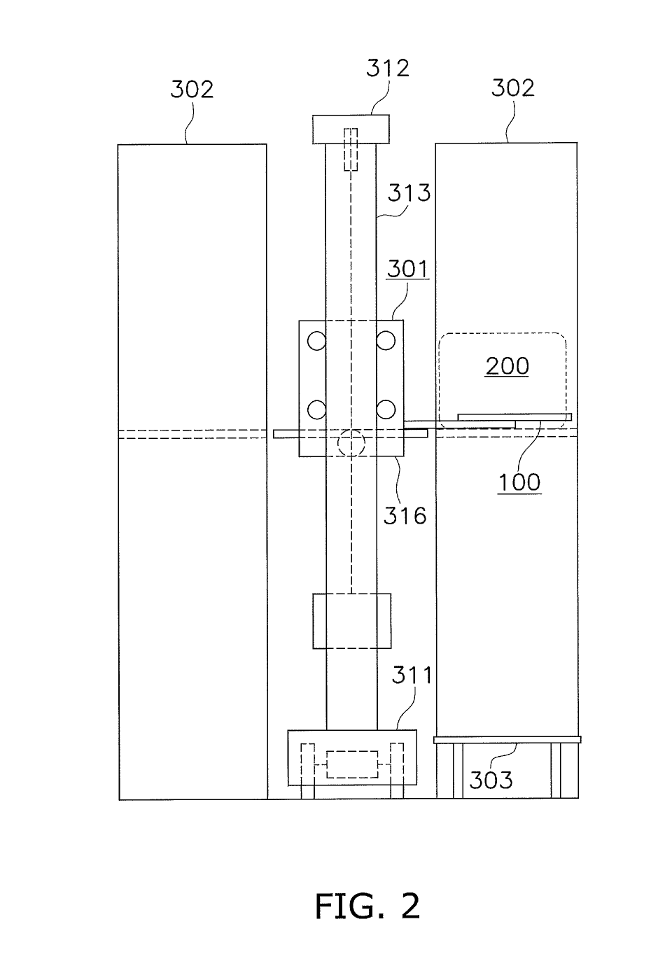

FIG. 2 is a side view showing schematically the automatic warehouse.

The stacker crane 301 has a structure in which a lower cart 311 and an upper cart 312 are connected by a mast 313 so that an elevation table 316 is able to move up and down along the mast 313.

The elevation table 316 is provided with the transfer device 100.

### First Preferred Embodiment

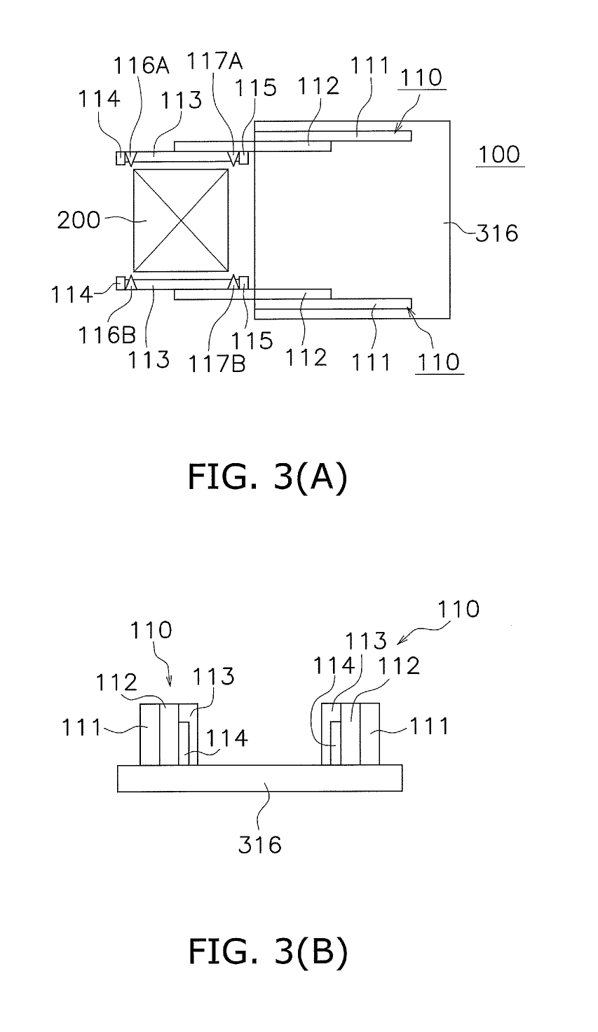

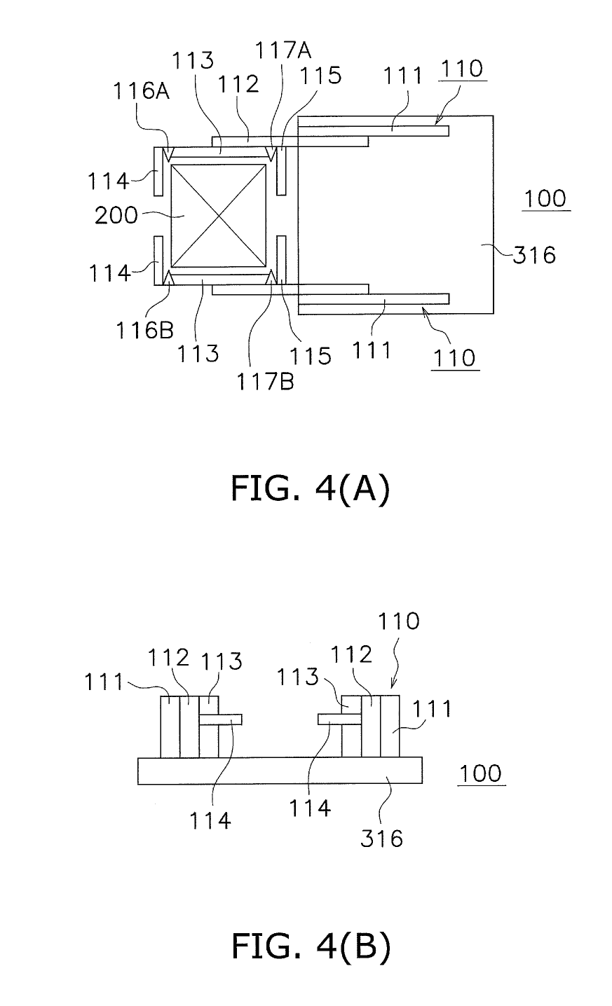

FIGS. 3A and 3B are explanatory diagrams of the transfer device 100 according to the first preferred embodiment of the present invention. FIG. 3A shows a plan view in the case where a hook is in a retract position, and FIG. 3B shows a side view thereof. FIGS. 4A and 4B are explanatory diagrams of the transfer device 100 according to the first preferred embodiment. FIG. 4A shows a plan view in the case where the hook is in an action position, and FIG. 4B is a side view thereof. Note that in FIG. 3A and FIG. 4A, the left and right direction is a first horizontal direction, and the up and down direction is a second horizontal direction.

The transfer device 100 (an example of the transfer device) is a device configured to transfer the article 200 (an example of the article) between the elevation table 316 and the shelf 302 and includes a pair of slide arms 110 (an example of the slide arms and an example of the pair of arm portions). The slide arm 110 is configured to slide corresponding to an estimated maximum size of the article 200 to be stored on the shelf 302. Even if there are the articles 200 having different sizes, the transfer process is performed corresponding to the sizes.

The pair of slide arms 110 are disposed with a space between them in the second horizontal direction. Each slide arm 110 includes a base arm 111, a middle arm 112, a top arm 113, a first hook 114 (an example of the engagement member or the first engagement member), and a second hook 115. Note that the first hook 114 includes a pair of hooks (an example of the engagement portions) attached to the slide arms, and the second hook 115 includes a pair of hooks attached to the slide arms.

The base arm 111 is secured to the elevation table 316. The middle arm 112 is supported by the base arm 111 in a slidable manner in the first horizontal direction, and supports the top arm 113 in a slidable manner in the first horizontal direction. When the middle arm 112 and the top arm 113 are moved to slide relative to the base arm 111, the top arm 113 is inserted into the shelves 302 on both sides.

The first hook 114 is attached to an end of the top arm 113 and is configured to move between the action position protruding toward the article 200 as shown in FIGS. 4A and 4B (an example of the action position) and the retract position not contacting with the article 200 as shown in FIGS. 3A and 3B (an example of the retract position).

For instance, the first hook 114 is attached to a rotation shaft disposed along a length direction of the top arm 113 and is configured to be rotated by an actuator (not shown) so as to move between the action position and the retract position.

The structure of the first hook 114 is not limited to the illustrated structure as long as it can move between the action position protruding toward the article 200 so as to engage with an end of the article 200 and the retract position not contacting with the article 200.

The second hook 115 is attached to an end of the top arm 113 and is configured to move between the action position protruding toward the article 200 and the retract position not contacting with the article 200.

For instance, similarly to the first hook 114, the second hook 115 is attached to a rotation shaft disposed along the length direction of the top arm 113 and is configured to be rotated by an actuator (not shown) so as to move between the action position and the retract position. A common rotation shaft and a common actuator preferably are used for the first hook 114 and the second hook 115.

The structure of the second hook 115 is not limited to the illustrated structure as long as it can move between the action position protruding toward the article 200 so as to engage with an end of the article 200 and the retract position not contacting with the article 200.

The pair of slide arms 110 preferably slide integrally or synchronously with each other by an actuator (not shown) with respect to the placed article 200.

The top arm 113 includes a first end detection sensor 116A, 116B (an example of the end detector) disposed close to the first hook 114 so as to detect the end of the article 200. The first end detection sensor 116A, 116B is a sensor configured to detect the end position of the article at a position close to the end position of the article 200 in the sliding direction of the slide arm 110 (more specifically, when the position in the sliding direction is identical or close to the end position of the article 200). Specifically, the first end detection sensor 116A, 116B is disposed adjacent to the first hook 114 on a proximal side of the slide arm 110.

If the transparent type optical sensor is used as the first end detection sensor 116A, 116B, one is a light emitter while the other is a light receiver. In addition, it is also possible to use a diffuse reflection type optical sensor as the first end detection sensor.

Using the transparent type optical sensor as the first end detection sensor 116A, 116B, when the slide arm 110 is moved to slide, the first end detection sensor 116A, 116B detects a position at which the light receiver changes from a light receiving state to a non-light receiving state and a position at which the light receiver changes from the non-light receiving state to the light receiving state, as an end of the article 200 on the elevation table 316 side or an end of the same on the shelf 302 side (an example of the distal end position).

The top arm 113 includes a second end detection sensor 117A, 117B disposed close to the second hook 115 so as to detect the end of the article 200.

Similarly to the first end detection sensor 116A, 116B, a transparent type optical preferably is used as the second end detection sensor 117A, 117B. In addition, it is also possible to use a diffuse reflection type optical sensor as the second end detection sensor.

Using the transparent type optical sensor as the second end detection sensor 117A, 117B, when the slide arm 110 is moved to slide, the second end detection sensor 117A, 117B detects a position at which the light receiver changes from a light receiving state to a non-light receiving state and a position at which the light receiver changes from the non-light receiving state to the light receiving state, as an end of the article 200 on the elevation table 316 side or an end of the same on the shelf 302 side.

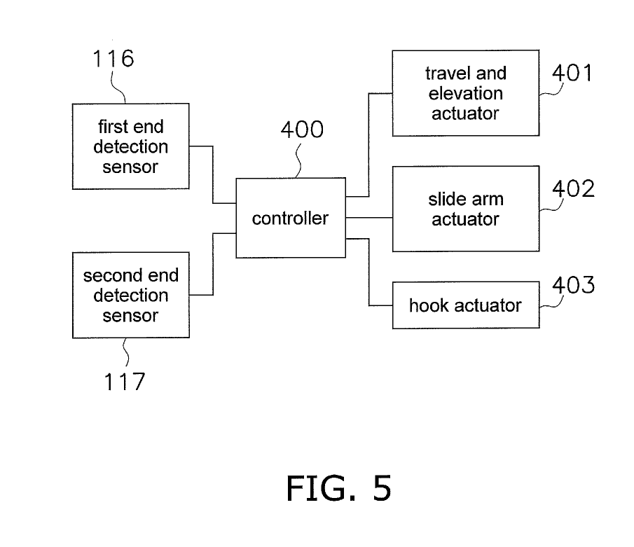

FIG. 5 is a control block diagram of the first preferred embodiment.

The transfer device 100 includes a controller 400 configured or programmed to control individual units. The controller 400 preferably includes a microprocessor including a CPU, a ROM, a RAM, and the like, for example.

The controller 400 is connected to a slide arm actuator 402 to move the slide arm 110 to slide relative to the shelf 302.

In addition, the controller 400 is connected to a hook actuator 403 to move the first hook 114 and the second hook 115 attached to the slide arm 110 between the action position and the retract position.

Further, the controller 400 is connected to the first end detection sensor 116 and the second end detection sensor 117 so as to receive detection signals from the sensors.

If the transfer device 100 is configured to be included in the stacker crane 301, the controller 400 also preferably controls each unit of the stacker crane 301. In this case, for example, the controller 400 is connected to a travel and elevation actuator 401, which moves a main body portion including the lower cart 311 and the upper cart 312 connected by the mast 313 to travel along the traveling rail, and moves the elevation table 316 up and down to a position to transfer among the multiple shelves 302.

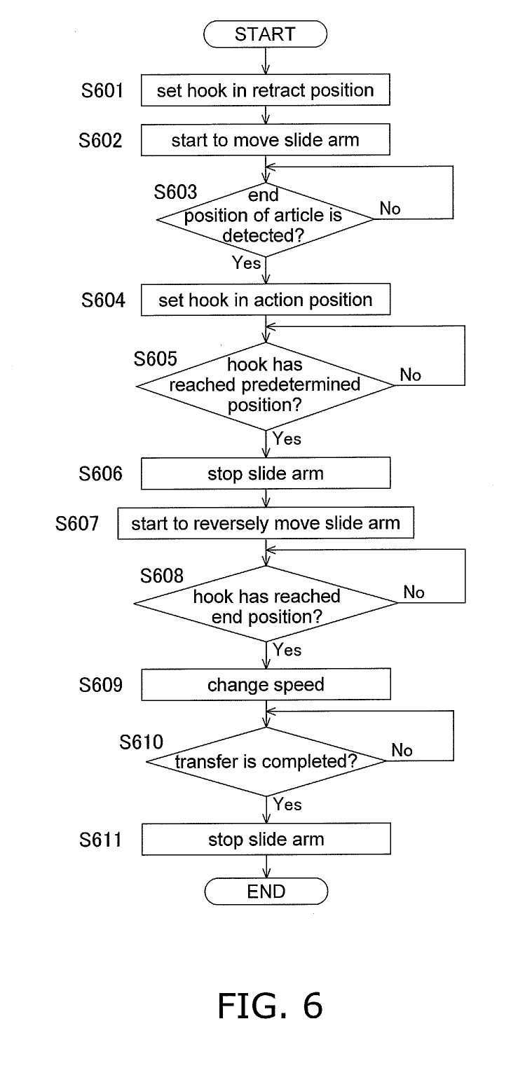

FIG. 6 is a control flowchart of the first preferred embodiment.

Here, an operation when transferring the article 200 stored on the shelf 302 to the elevation table 316 of the stacker crane 301 is described.

In Step S601, the controller 400 sets the first hook 114 in the retract position. If the first hook 114 is in the action position as an initial state, the controller 400 transmits a control signal to the hook actuator 403 so that the first hook 114 moves to the retract position. In addition, if the first hook 114 is in the retract position as the initial state, the controller 400 transmits a control signal to the hook actuator 403 so that the first hook 114 maintains the current state. In this case, the second hook 115 may be in either the action position or the retract position.

In Step S602, the controller 400 starts to move the slide arm 110 toward the shelf 302. The controller 400 transmits the control signal to the slide arm actuator 402 so that the first hook 114 reaches a predetermined position over a distal end position of the article 200, and starts to move the slide arm 110 to slide.

In Step S603, the controller 400 determines whether or not the distal end position of the article 200 is detected. The controller 400 detects the distal end position of the article 200 based on a detection signal from the first end detection sensor 116. As described above, if the first end detection sensor 116 is a transparent type optical sensor, for example, the controller 400 detects a position at which the light receiver changes from the non-light receiving state to the light receiving state as the distal end position of the article 200.

The controller 400 maintains the moving state of the slide arm 110 until determining that the distal end position of the article 200 is detected, and proceeds to Step S604 if it is determined that the distal end position of the article 200 is detected.

In Step S604, the controller 400 determines that the first hook 114 has passed the distal end position of the article 200 and starts to move the first hook 114 to the action position. The controller 400 transmits the control signal to the hook actuator 403 so as to start to move the first hook 114 from the retract position to the action position.

In Step S605, the controller 400 determines whether or not the first hook 114 has reached a predetermined position in the moving direction of the slide arm 110. For instance, if the slide arm actuator 402 includes a stepping motor with a servo mechanism, for example, the controller 400 is configured or programmed to determine that the first hook 114 has moved the slide arm 110 to the predetermined position in accordance with the number of drive pulses. In addition, it is possible to dispose a sensor to detect a front end position of the slide arm 110 or a position of the first hook 114 so that the controller 400 determines whether or not the slide arm 110 has moved until the first hook 114 reaches the predetermined position based on a detection signal from the sensor. The structure to determine whether or not the first hook 114 has reached the predetermined position is not limited to the one described above, and various structures can be adopted.

The controller 400 maintains the moving state of the slide arm 110 until determining that the first hook 114 has reached the predetermined position, and proceeds to Step S606 if it is determined that the first hook 114 has reached the predetermined position.

In Step S606, the controller 400 stops the slide arm 110.

In Step S607, the controller 400 confirms that the first hook 114 is positioned in the action position and afterwards starts to move the slide arm 110 to slide toward the elevation table 316. If it is determined that the first hook 114 is in the action position by the hook actuator 403 based on a feedback of the control amount from the hook actuator 403 or the detection signal from the sensor to detect a position of the first hook 114, the controller 400 transmits a control signal to the slide arm actuator 402 so as to move at low speed until the first hook 114 in the action position reaches the distal end position of the article 200.

In Step S608, the controller 400 determines whether or not the first hook 114 has reached the distal end position of the article 200. The controller 400 preferably is configured to specify the end position of the article 200 based on a detection signal of the first end detection sensor 106 and stores the same in a predetermined storage area when the slide arm 110 is moved to slide toward the article 200. In this case, the controller 400 determines whether or not the first hook 114 has reached the stored distal end position of the article 200 in accordance with a movement amount of the slide arm 110.

The controller 400 maintains the moving state of the slide arm 110 until determining that the first hook 114 has reached the distal end position of the article 200, and proceeds to Step S609 if it is determined that the first hook 114 has reached the distal end position of the article 200.

In Step S609, the controller 400 changes the movement speed of the slide arm 110. The controller 400 transmits a control signal to the slide arm actuator 402 so as to increase the movement speed of the slide arm 110 in the state where the first hook 114 contacts with the distal end position of the article 200. Note that it is possible to increase the movement speed of the slide arm 110 to high speed before the first hook 114 has reached the distal end position of the article 200.

In Step S610, the controller 400 determines whether or not the transfer of the article 200 by the slide arm 110 is completed. If the slide arm actuator 402 includes a stepping motor with a servo mechanism, the controller 400 determines that the transfer of the article 200 to the elevation table 316 is completed in accordance with the number of drive pulses. In addition, it is possible to dispose a sensor to detect the front end position of the slide arm 110 so that the controller 400 determines whether or not the slide arm 110 has reached a predetermined position on the elevation table 316 based on the detection signal from the sensor.

The controller 400 maintains the moving state of the slide arm 110 until determining that the transfer of the article 200 is completed and proceeds to Step S611 if it is determined that the transfer of the article 200 is completed.

In Step S611, the controller 400 stops the slide arm 110. The controller 400 transmits a control signal to the slide arm actuator 402 so as to stop the slide of the slide arm 110.

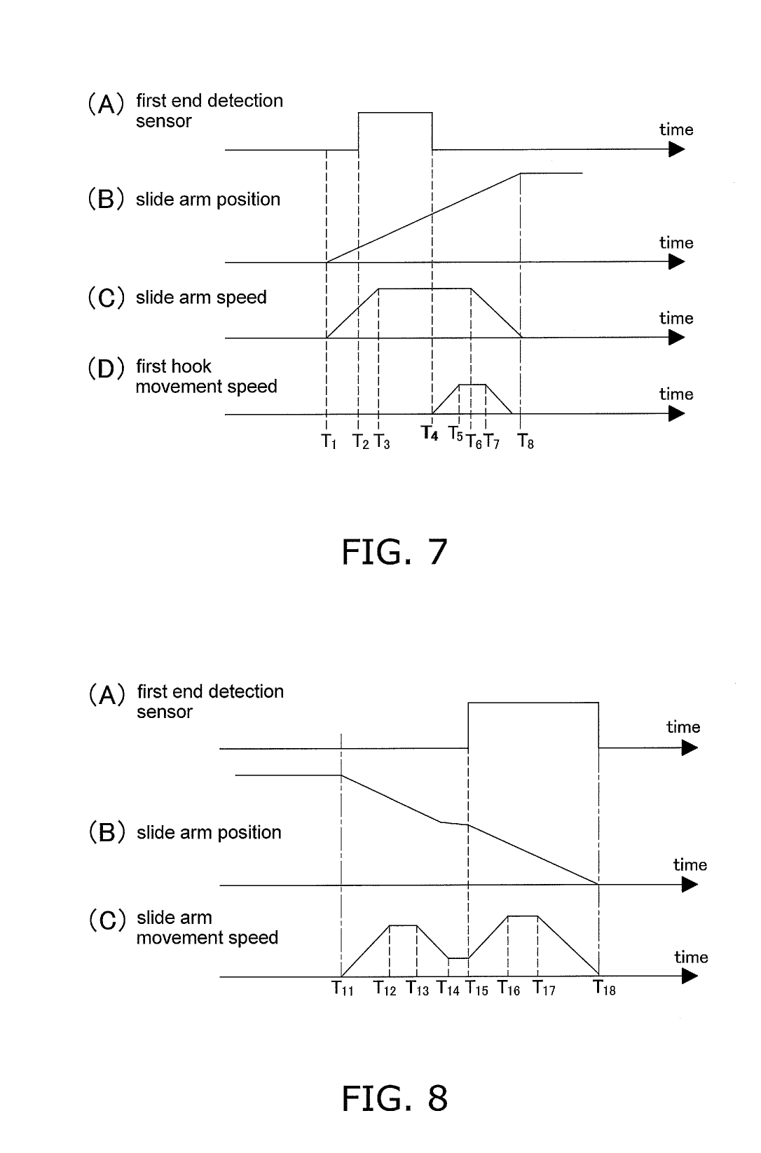

FIG. 7 is a timing chart of a sliding operation of the slide arm 110 toward the shelf 302 when transferring the article 200 stored on the shelf 302 onto the elevation table 316 of the stacker crane 301. 7(A) shows a detection signal of the first end detection sensor 116. 7(B) shows a position of the slide arm 110. 7(C) shows a movement speed of the slide arm 110. 7(D) shows a movement speed of the first hook 114.

As shown in FIG. 7, the controller 400 transmits a control signal to the slide arm actuator 402 at time point T1 so as to start to move the slide arm 110 to slide. In this case, the slide arm 110, which is driven by the slide arm actuator 402, increases the movement speed to reach the highest speed at time point T3.

In 7(A), the detection signal of the first end detection sensor 116 changes from a first state to a second state at time point T2 and changes from the second state to the first state at time point T4. The controller 400 determines that the end position (proximal end position) of the article 200 on the elevation table 316 side is detected at the time point T2 and that the end position of the article 200 on the shelf 302 side (distal end position) is detected at the time point T4, based on the detection signal of the first end detection sensor 116.

The controller 400 transmits a control signal to the hook actuator 403 at the time point T4 when the first end detection sensor 116 detects the distal end position of the article 200, so as to start to move the first hook 114 to the action position. Note that the timing when the controller 400 starts to move the first hook 114 to the action position may have a time lag from the time point T4. In particular, if it is difficult to smoothly move the first hook 114 from the retract position to the action position at the time point T4, it is preferred to move the first hook 114 to the action position when a predetermined time elapses from the time point T4. In this case, the first hook 114 driven by the hook actuator 403 increases the movement speed so as to reach the highest speed at time point T5.

When it is determined that the first hook 114 has reached the action position at time point T7, the controller 400 transmits a control signal to the hook actuator 403 so as to stop the movement of the first hook 114.

The controller 400 stops the movement of the slide arm 110 at time point T8 when the first hook 114 reaches a predetermined position. In FIG. 7, the controller 400 starts to decrease the movement speed of the slide arm 110 from time point T6 and controls the movement of the slide arm 110 so that the first hook 114 reaches a predetermined position.

Here, the predetermined position can be set to be a position at which the first hook 114 moves over the distal end position of the article 200 at earliest, and to be a position at which the first hook 114 can smoothly move from the retract position to the action position. It is possible to set the predetermined position to be a position of the first hook 114 when the slide arm 110 moves to the farthest position.

In this way, when moving the slide arm 110 to slide toward the shelf 302, the movement of the first hook 114 to the action position is started when the first end detection sensor 116 detects the distal end position of the article 200. Therefore, it is possible to complete the movement of the first hook 114 to the action position before the first hook 114 reaches the predetermined position.

Note that there is a case where the movement of the first hook 114 to the action position is not completed when the first hook 114 reaches the predetermined position. In this case, the controller 400 maintains the movement of the first hook 114 to the action position in the state where the first hook 114 is stopped at the predetermined position. In this case too, because the movement to the action position is started before the first hook 114 reaches the predetermined position, it is possible to shorten the movement time of the first hook 114 to the action position.

The slide movement of the slide arm 110 toward the shelf 302 is capable of being performed at high speed because it is sufficient to move the first hook 114 to the predetermined position so that the first hook 114 is positioned behind the distal end position of the article 200.

In this way, it is possible to shorten the movement time of the slide arm 110 toward the shelf 302.

FIG. 8 is a timing chart of a sliding operation of the slide arm 110 from the shelf 302 toward the elevation table 316 when transferring the article 200 stored on the shelf 302 onto the elevation table 316 of the stacker crane 301. 8(A) shows a detection signal of the first end detection sensor 116, 8(B) shows a position of the slide arm 110, and 8(C) shows a movement speed of the slide arm 110.

In this example, the slide movement of the slide arm 110 in the opposite direction is performed at relatively low speed until the first hook 114 reaches the distal end position of the article 200 and is performed at high speed after the first hook 114 has reached the distal end position of the article 200. Thus, damage to the article 200 is prevented while the transfer process of the article 200 is performed at high speed.

In the example shown in FIGS. 8A-8D, there is described the case in which assuming the case where there is a sufficient distance from the predetermined position to the distal end position of the article 200, the slide arm 110 is first moved at high speed, the movement speed of the slide arm 110 is decreased when the first hook 114 becomes close to the distal end position of the article 200, and further, the movement is performed at high speed after the first hook 114 reaches the distal end position of the article 200.

As shown in FIGS. 8A-8D, the controller 400 transmits a control signal to the slide arm actuator 402 at time point T11 so as to start the slide movement of the slide arm 110 in the opposite direction. In this case, the movement speed of the slide arm 110 driven by the slide arm actuator 402 is increased, and reaches the highest speed at time point T12.

If it is determined that the first hook 114 becomes close to the distal end position of the article 200, the controller 400 starts to decrease the movement speed of the slide arm 110. In FIGS. 8A-8D, the controller 400 determines that a distance between the first hook 114 and the distal end position of the article 200 becomes a predetermined value or smaller at time point T13, and starts to decrease the movement speed of the slide arm 110.

When the movement speed of the slide arm 110 reaches the predetermined value, the controller 400 maintains the movement speed. As shown in FIGS. 8A-8D, when it is determined that the speed of the slide arm 110 has reached the predetermined value at time point T14, the controller 400 maintains the speed of the slide arm. 110 until time point T15 when the first hook 114 reaches the distal end position of the article 200.

The movement speed of the slide arm 110 when it is decreased is set to such a degree that damage to the article 200 is prevented when the first hook 114 abuts against the distal end position of the article 200.

If it is determined that the first hook 114 has reached the distal end position of the article 200, the controller 400 starts to increase the movement speed of the slide arm 110. If the first hook 114 and the first end detection sensor 116 are attached to the substantially same position in the moving direction of the slide arm 110, the controller 400 determines that the first hook 114 has reached the distal end position of the article 200 at the time point T15 when the first end detection sensor 116 changes from the first state to the second state.

In addition, when moving the slide arm 110 to slide toward the shelf 302, the controller 400 specifies the end position of the article 200 based on the first end detection sensor 116 and store the detected position in a predetermined storage area. In this case, the controller 400 determines that the first hook 114 has reached the stored distal end position of the article 200 when the movement amount of the slide arm 110 reaches a predetermined amount. For instance, if the slide arm actuator 402 includes a stepping motor with a servo mechanism, it is possible to determine that the first hook 114 has reached the distal end position of the article 200 in accordance with the number of drive pulses.

The controller 400 starts to increase the movement speed of the slide arm 110 at the time point T15. In this case, the movement speed of the slide arm 110 driven by the slide arm actuator 402 is increased so as to reach the highest speed at time point T16.

When the movement speed of the slide arm 110 reaches the highest speed, the controller 400 controls to maintain the movement speed. As shown in FIGS. 8A-8C, if it is determined that the speed of the slide arm 110 has reached the predetermined value at the time point T16, the controller 400 controls to maintain the speed of the slide arm 110 until time point T17 when starting to decrease the movement speed of the slide arm 110.

The controller 400 decreases the movement speed of the slide arm 110 so that the first hook 114 stops at a position corresponding to a transfer position on the elevation table 316, and stops the slide arm 110 at time point T18.

In the first preferred embodiment, when transferring the article 200 placed on the shelf 302 to the elevation table 316 of the stacker crane 301, for example, the movement of the first hook 114 to the action position is performed while the slide arm 110 is moved to slide. Therefore, it is possible to perform the fast transfer process.

In addition, because the speed of the first hook 114 is decreased when it abuts against the end position of the article 200, it is possible to prevent damage to the article 200.

### Second Preferred Embodiment

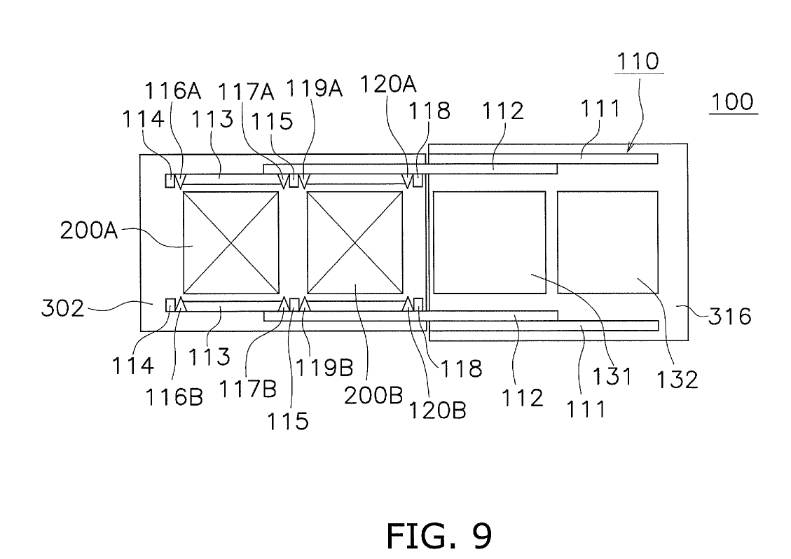

FIG. 9 is an explanatory diagram of the transfer device 100 according to a second preferred embodiment of the present invention.

In the second preferred embodiment, there is shown the transfer device 100 capable of simultaneously transferring two articles 200A and 200B placed in series in the moving direction of the slide arm 110, in which the same element or portion as in the first preferred embodiment is denoted by the same reference numeral.

The transfer device 100 (an example of the transfer device) is a device for transferring the article 200 (an example of the article) between the elevation table 316 and the shelf 302, and is equipped with a pair of slide arms 110 (an example of the slide arm).

The pair of slide arms 110 are disposed with an interval between them in the second horizontal direction. Each of the slide arms 110 includes the base arm 111, the middle arm 112, the top arm 113, the first hook 114, the second hook 115, and a third hook 118.

The base arm 111 is fixed to the elevation table 316. The middle arm 112 is supported by the base arm 111 in a slidable manner in the first horizontal direction, and supports the top arm 113 in a slidable manner in the first horizontal direction. By moving the middle arm 112 and the top arm 113 to slide relative to the base arm 111, the top arm 113 is inserted into the shelves 302 on both sides.

The first hook 114 is attached to the end of the top arm 113 and moves between the action position protruding toward the article 200 (an example of the action position) and the retract position not contacting with the article 200 as shown in FIGS. 3A and 3B (an example of the retract position).

For instance, the first hook 114 is attached to the rotation shaft disposed along the length direction of the top arm 113 and preferably is be configured to be rotated by an actuator (not shown) so as to move between the action position and the retract position.

The structure of the first hook 114 is not limited to the one shown in the pulling as long as it protrudes toward the article 200 and preferably is configured to move between the action position engaging with the end of the article 200 and the retract position not contacting with the article 200.

The second hook 115 is attached so as to be positioned at a middle portion of the top arm 113 in the first horizontal direction, and is configured to move between the action position protruding toward the article 200 and the retract position not contacting with the article 200.

For instance, similarly to the first hook 114, the second hook 115 is attached to the rotation shaft disposed along the length direction of the top arm 113 and is configured to be rotated by an actuator (not shown) so as to move between the action position and the retract position. A common rotation shaft and a common actuator preferably is used for the first hook 114 and the second hook 115.

The structure of the second hook 115 is not limited to the one shown in the pulling as long as it protrudes toward the article 200 and preferably moves between the action position engaging with the end of the article 200 and the retract position not contacting with the article 200.

The third hook 118 is attached to the end of the top arm 113 and preferably moves between the action position protruding toward the article 200 and the retract position not contacting with the article 200.

For instance, similarly to the first hook 114, the second hook 115 is attached to the rotation shaft disposed along the length direction of the top arm 113 and preferably is configured to be rotated by an actuator (not shown) so as to move between the action position and the retract position. A common rotation shaft and a common actuator preferably is used for the first hook 114, the second hook 115, and the third hook 118.

The structure of the third hook 118 is not limited to the one shown in the pulling as long as it protrudes toward the article 200 and preferably moves between the action position engaging with the end of the article 200 and the retract position not contacting with the article 200.

The pair of slide arms 110 preferably is moved by an actuator (not shown) to slide integrally or synchronously with each other relative to the placed article 200.

The top arm 113 is provided with the first end detection sensor 116A, 116B disposed close to the first hook 114 so as to detect the end of the article 200. The first end detection sensor 116A, 116B is a sensor configured to detect the end position of the article at a position close to the end position of the article 200 in the sliding direction of the slide arm 110 (more specifically, when the position in the sliding direction is identical or close to the end position of the article 200). Note that other end detection sensors described below are also equivalent sensors. Specifically, the first end detection sensor 116A, 116B is disposed adjacent to the first hook 114 on a proximal side of the slide arm 110.

If a transparent type optical sensor is used as the first end detection sensor 116A, 116B, one is a light emitter while the other is a light receiver. In addition, it is also possible to use a diffuse reflection type optical sensor as the first end detection sensor.

Using the transparent type optical sensor as the first end detection sensor 116A, 116B, when the slide arm 110 is moved to slide, the first end detection sensor 116A, 116B detects a position at which the light receiver changes from a light receiving state to a non-light receiving state, and a position at which the light receiver changes from the non-light receiving state to the light receiving state, as the end of the article 200 on the elevation table 316 side or the end of the same on the shelf 302 side (an example of the distal end position).

The top arm 113 includes the second end detection sensor 117A, 117B and a third end detection sensor 119A, 119B disposed close to the second hook 115 so as to detect the end of the article 200.

The second end detection sensor 117A, 117B is attached adjacent to the left side (distal side) of the second hook 115 in the pulling, and the third end detection sensor 119A, 119B is attached adjacent to the right side (proximal side) of the second hook 115 in the pulling.

A transparent type optical sensor preferably is used as the second end detection sensor 117A, 117B and the third end detection sensor 119A, 119B similarly to the first end detection sensor 116A, 116B. In addition, it is also possible to use a diffuse reflection type optical sensor as the second end detection sensor and the third end detection sensor.

Using the transparent type optical sensor as the second end detection sensor 117A, 117B and the third end detection sensor 119A, 119B, when the slide arm 110 is moved to slide, the second end detection sensor 117A, 117B and the third end detection sensor 119A, 119B detect a position at which the light receiver changes from a light receiving state to a non-light receiving state and a position at which the light receiver changes from the non-light receiving state to the light receiving state, as end positions of the article 200 in the transporting direction.

The top arm 113 is provided with a fourth end detection sensor 120A, 120B disposed adjacent to the third hook 118 so as to detect the end of the article 200.

A transparent type optical sensor preferably is used as the fourth end detection sensor 120A, 120B similarly to the first end detection sensor 116A, 116B. In addition, it is also possible to use a diffuse reflection type optical sensor as the fourth end detection sensor.

Using the transparent type optical sensor as the fourth end detection sensor 120A, 120B, when the slide arm 110 is moved to slide, the fourth end detection sensor 120A, 120B detects a position at which the light receiver changes from a light receiving state to a non-light receiving state and a position at which the light receiver changes from the non-light receiving state to the light receiving state, as end positions in the transporting direction of the article 200.

The elevation table 316 is provided with a first conveyor 131 and a second conveyor 132 disposed in series in the moving direction of the slide arm 110. Each of the first conveyor 131 and the second conveyor 132 preferably transports the article 200 and is driven by an actuator (not shown) so that the article 200 is transferred between them.

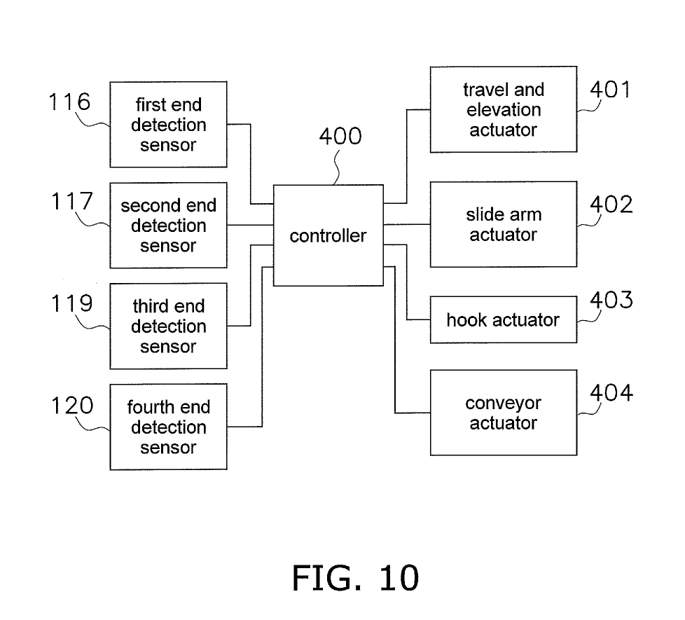

FIG. 10 is a control block diagram of the second preferred embodiment.

The transfer device 100 includes the controller 400 configured or programmed to control individual units. The controller 400 preferably includes a microprocessor including a CPU, a ROM, a RAM, and the like, for example.

The controller 400 is connected to the slide arm actuator 402 to move the slide arm 110 to slide relative to the shelf 302.

In addition, the controller 400 is connected to the hook actuator 403 to move the first hook 114, the second hook 115, and the third hook 118 attached to the slide arm 110 between the action position and the retract position.

Further, the controller 400 is connected to a conveyor actuator 404 to drive the first conveyor 131 and the second conveyor 132.

In addition, the controller 400 is connected to the first end detection sensor 116, the second end detection sensor 117, the third end detection sensor 119, and the fourth end detection sensor 120 so as to receive detection signals from the sensors.

If the transfer device 100 is included in the stacker crane 301, the controller 400 also controls each unit of the stacker crane 301. In this case, for example, to the controller 400 is connected to the travel and elevation actuator 401, which moves the main body portion including the lower cart 311 and the upper cart 312 connected by the mast 313 to travel along the traveling rail, and moves the elevation table 316 up and down to a position to transfer among the multiple shelves 302.

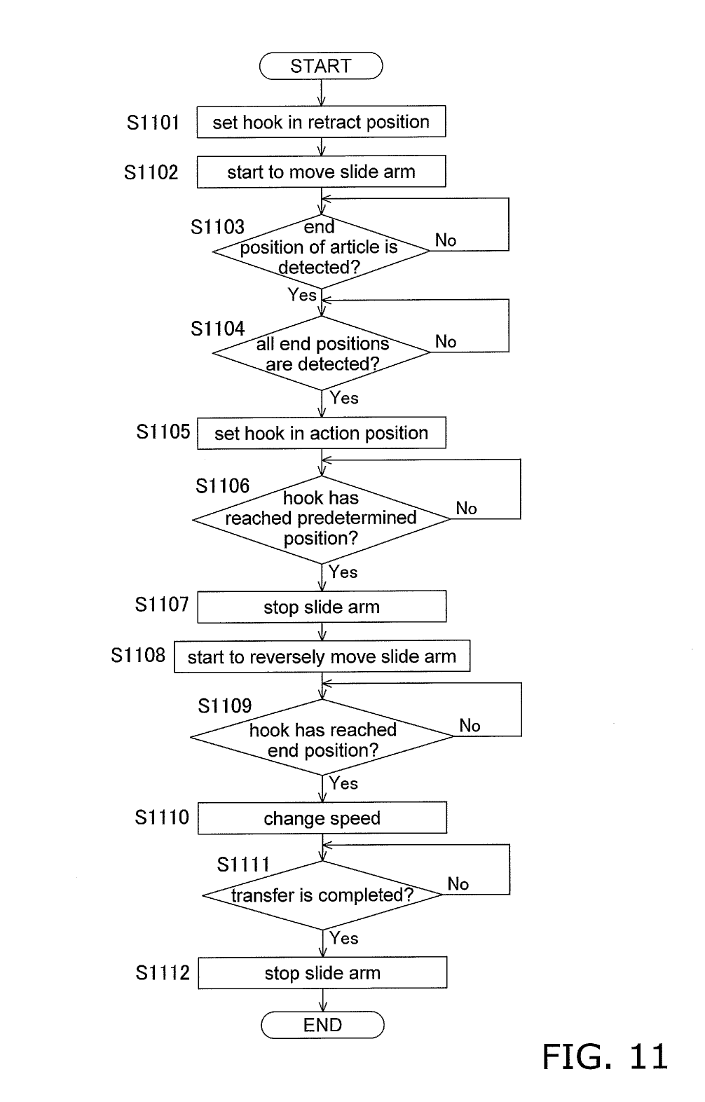

FIG. 11 is a control flowchart of the second preferred embodiment.

Here, an operation when transferring two articles 200A (an example of the first article) and 200B (an example of the second article) stored on the shelf 302 to the elevation table 316 of the stacker crane 301 is described.

In Step S1101, the controller 400 sets the first hook 114 (an example of the first engagement member) in the retract position. If the first hook 114 is in the action position as the initial state, the controller 400 transmits a control signal to the hook actuator 403 so that the first hook 114 moves to the retract position. In addition, if the first hook 114 is in the retract position as the initial state, the controller 400 transmits a control signal to the hook actuator 403 so that the first hook 114 maintains the current state.

It is preferred that the second hook 115 (an example of the second engagement member) is set in the retract position in synchronization with the first hook 114. In addition, the third hook 118 may be in either the retract position or the action position.

In Step S1102, the controller 400 starts the movement of the slide arm 110 toward shelf 302. The controller 400 transmits a control signal to the slide arm actuator 402 so that the first hook 114 reaches a predetermined position over the distal end position of the article 200, and starts the slide movement of the slide arm 110.

In Step S1103, the controller 400 determines whether or not the distal end position of the article 200 is detected. Specifically, the controller 400 detects the distal end position of the article 200A or 200B based on a detection signal input from the first end detection sensor 116 (an example of the first end detector) or the third end detection sensor 119 (an example of the second end detector). As described above, if the first end detection sensor 116 or the third end detection sensor 119 preferably is a transparent type optical sensor, the controller 400 detects a position at which the light receiver changes from the non-light receiving state to the light receiving state as the distal end position of the article 200A or 200B.

The controller 400 maintains the moving state of the slide arm 110 until it is determined that the distal end position of the article 200A or 200B is detected, and proceeds to Step S1104 if it is determined that the distal end position of the article 200A or 200B is detected.

In Step S1104, the controller 400 determines whether or not the distal end positions of the all articles 200A and 200B are detected. When the end positions are detected by the first end detection sensor 116 and the third end detection sensor 119, the controller 400 determines that the detection of the distal end positions of the all articles 200A and 200B is completed and proceeds to Step S1105.

In Step S1105, the controller 400 determines that the first hook 114 has passed the distal end position of the article 200A and further the second hook 115 has passed the distal end position of the article 200B, and starts to move the first hook 114 and the second hook 115 to the action position. The controller 400 transmits a control signal to the hook actuator 403 so as to start to move the first hook 114 and the second hook 115 from the retract position to the action position.

In Step S1106, the controller 400 determines whether or not the first hook 114 and the second hook 115 have reached the predetermined position in the moving direction of the slide arm 110. For instance, if the slide arm actuator 402 includes a stepping motor with a servo mechanism, the controller 400 determines that the slide arm 110 is moved until the first hook 114 and the second hook 115 reach the predetermined position in accordance with the number of drive pulses. In addition, it is possible to dispose a sensor configured to detect the front end position of the slide arm 110 or positions of the first hook 114 and the second hook 115, so that the controller 400 determines whether or not the slide arm 110 has moved until the first hook 114 and the second hook 115 reach the predetermined position based on a detection signal from the sensor. The structure configured to determine whether or not the first hook 114 and the second hook 115 have reached the predetermined position is not limited to the one described above, and various structures can be adopted.

The controller 400 maintains the moving state of the slide arm 110 until determining that the first hook 114 and the second hook 115 have reached the predetermined position, and proceeds to Step S1107 if it is determined that the first hook 114 and the second hook 115 have reached the predetermined position.

In Step S1107, the controller 400 stops the slide movement of the slide arm 110 toward the shelf 302.

In Step S1108, the controller 400 checks that the first hook 114 and the second hook 115 are in the action position, and afterwards starts the slide movement of the slide arm 110 toward the elevation table 316. When the controller 400 determines that the first hook 114 and the second hook 115 are in the action position based on a feedback of the control amount from the hook actuator 403 or the detection signal from the sensor configured to detect the position of the first hook 114 and the second hook 115, the controller 400 transmits a control signal to the slide arm actuator 402 so that the first hook 114 and the second hook 115 in the action position move at low speed until reaching the distal end positions of the articles 200A and 200B.

In Step S1109, the controller 400 determines whether or not the first hook 114 and the second hook 115 have reached the distal end positions of the articles 200A and 200B. When moving the slide arm 110 to slide toward the articles 200A and 200B, the controller 400 stores the distal end positions of the articles 200A and 200B detected by the first end detection sensor 116 and the third end detection sensor 119, and determines whether or not the first hook 114 and the second hook 115 have reached the stored end position based on the movement amount of the slide arm 110.

The controller 400 maintains the moving state of the slide arm 110 until determining that the first hook 114 and the second hook 115 have reached the distal end positions of the articles 200A and 200B, and proceeds to Step S1110 if it is determined that the first hook 114 and the second hook 115 have reached the distal end positions of the articles 200A and 200B.

In Step S1110, the controller 400 changes the movement speed of the slide arm 110. The controller 400 transmits a control signal to the slide arm actuator 402 so as to increase the movement speed of the slide arm 110 in the state where the first hook 114 and the second hook 115 have reached the distal end positions of the articles 200A and 200B. Note that it is possible to increase the movement speed of the slide arm 110 to high speed before the first hook 114 and the second hook 115 reach the distal end positions of the articles 200A and 200B.

In Step S1111, the controller 400 determines whether or not the transfer of the articles 200A and 200B by the slide arm 110 is completed. If the slide arm actuator 402 includes a stepping motor including a servo mechanism, the controller 400 determines whether or not the transfer of the articles 200A and 200B to the elevation table 316 is completed based on the number of drive pulses. In addition, it is possible to dispose a sensor configured to detect the front end position of the slide arm 110, so that the controller 400 determines whether or not the slide arm 110 has reached the predetermined position on the elevation table 316 based on a detection signal from the sensor.

The controller 400 maintains the moving state of the slide arm 110 until determining that the transfer of the articles 200A and 200B is completed, and proceeds to Step S1112 if it is determined that the transfer of the articles 200A and 200B is completed.

In Step S1112, the controller 400 stops the slide arm 110. The controller 400 transmits a control signal to the slide arm actuator 402 so as to finish the slide movement of the slide arm 110.

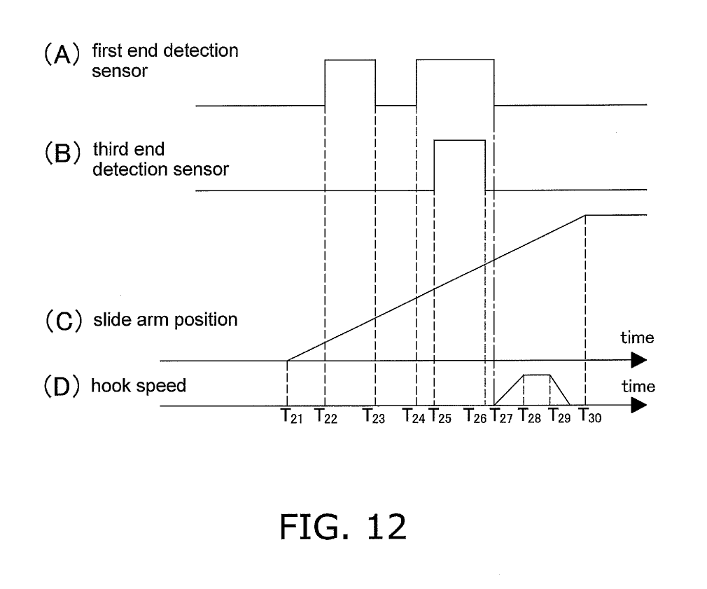

FIG. 12 is a timing chart of an operation of moving the slide arm 110 to slide toward the shelf 302 when transferring the articles 200A and 200B stored on the shelf 302 to the elevation table 316 of the stacker crane 301. 12(A) shows the detection signal of the first end detection sensor 116, 12(B) shows the detection signal of the third end detection sensor 119, 12(C) shows the movement position of the slide arm 110, and 12(D) shows the movement speed of the first hook 114 and the second hook 115.

As shown in FIG. 12, the controller 400 transmits a control signal to the slide arm actuator 402 at time point T21 so as to start the slide movement of the slide arm 110.

In 12(A), the detection signal of the first end detection sensor 116 changes from the first state to the second state at time point T22, and changes from the second state to the first state at time point T23.

Therefore, the controller 400 determines that the first end detection sensor 116 has detected the end position (proximal end position) of the article 200B on the elevation table 316 side at the time point T22 and has detected the end position (distal end position) of the article 200B on the shelf 302 side at the time point T23.

In addition, the detection signal of the first end detection sensor 116 changes from the first state to the second state at time point T24, and changes from the second state to the first state at time point T27.

Therefore, the controller 400 determines that the first end detection sensor 116 has detected the end position (proximal end position) of the article 200A on the elevation table 316 side at the time point T24 and has detected the end position (distal end position) of the article 200A on the shelf 302 side at the time point T27.

In 12(B), the detection signal of the third end detection sensor 119 changes from the first state to the second state at time point T25 and changes from the second state to the first state at time point T26.

Therefore, the controller 400 determines that the third end detection sensor 119 has detected the end position (proximal end position) of the article 200B on the elevation table 316 side at the time point T25 and has detected the end position (distal end position) of the article 200B on the shelf 302 side at the time point T26.

Therefore, the controller 400 determines that the third end detection sensor 119 has detected the distal end position of the article 200B to be transferred by the second hook 115 at the time point T26 and the first end detection sensor 116 has detected the distal end position of the article 200A to be transferred by the first hook 114 at the time point T27.

The controller 400 starts the movement of the first hook 114 and the second hook 115 to the action position on the basis of a later one of timings at which the distal end position is detected. In the illustrated example, the controller 400 transmits a control signal to the hook actuator 403 at the time point T27 so as to start the movement of the first hook 114 and the second hook 115.

Note that the timing when the controller 400 starts the movement of the first hook 114 and the second hook 115 to the action position may have a time lag from the time point T27. In particular, if it is difficult for the first hook 114 or the second hook 115 to smoothly move from the retract position to the action position at the time point T27, it is preferred to move the first hook 114 and the second hook 115 to the action position a predetermined after the time point T27.

In this case, the movement speed of the first hook 114 and the second hook 115 driven by the hook actuator 403 increases so as to reach the highest speed at time point T28.

When it is determined that the first hook 114 and the second hook 115 have reached the action position at the time point T28, the controller 400 transmits a control signal to the hook actuator 403 so as to stop the movement of the first hook 114 and the second hook 115.

The controller 400 stops the movement of the slide arm 110 at time point T30 when the first hook 114 reaches the predetermined position.

Here, the predetermined position preferably is set to be a position at which the first hook 114 moves over the distal end position of the article 200A and the second hook 115 moves over the distal end position of the article 200B at the earliest, and to be a position at which the first hook 114 and the second hook 115 smoothly moves from the retract position to the action position.

In this way, when moving the slide arm 110 to slide toward the shelf 302, the movement of the first hook 114 and the second hook 115 to the action position is started on the basis of the later one of the timings when the first end detection sensor 116 and the third end detection sensor 119 have detected the distal end positions of the articles 200A and 200B. Therefore, it is possible to complete the movement of the first hook 114 and the second hook 115 to the action position before the maximum movement of the slide arm 110 is completed.

Note that there is a case where the movement of the first hook 114 and the second hook 115 to the action position is not completed when the first hook 114 and the second hook 115 reaches the predetermined position. In this case, the controller 400 maintains the movement of the first hook 114 and the second hook 115 to the action position in the state where the first hook 114 and the second hook 115 is stopped at the predetermined position. In this case too, because the movement to the action position is started before the first hook 114 and the second hook 115 reach the predetermined position, it is possible to shorten the movement time of the first hook 114 and the second hook 115 to the action position.

The slide movement of the slide arm 110 toward the shelf 302 preferably is performed at high speed because it is sufficient to move the first hook 114 to the predetermined position so that the first hook 114 is positioned behind the distal end position of the article 200.

In this way, it is possible to shorten the movement time of the slide arm 110 toward the shelf 302.

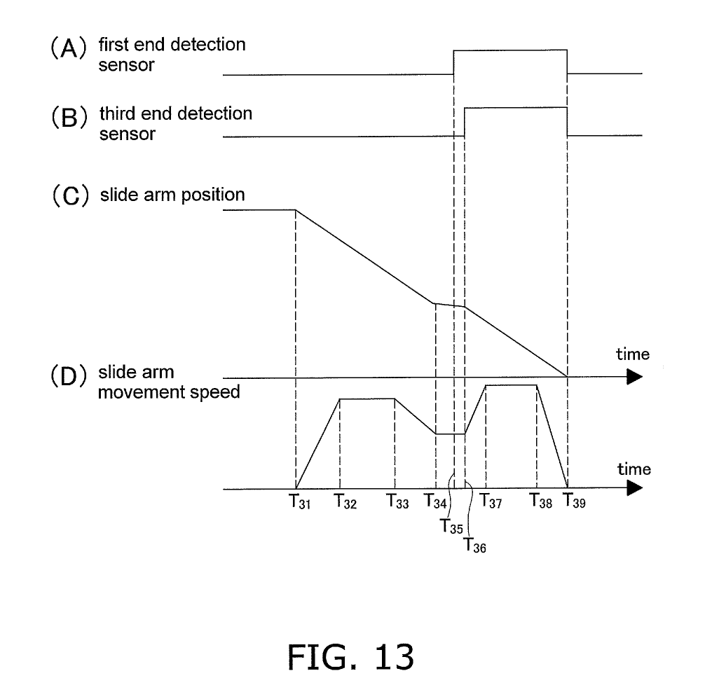

FIG. 13 is a timing chart of a sliding operation of the slide arm 110 from the shelf 302 toward the elevation table 316 when transferring the articles 200A and 200B stored on the shelf 302 onto the elevation table 316 of the stacker crane 301. 13(A) shows a detection signal of the first end detection sensor 116, 13(B) shows a detection signal of the third end detection sensor 119, 13(C) shows a position of the slide arm 110, and 13(D) shows a movement speed of the slide arm 110.

In this example, the slide movement of the slide arm 110 in the opposite direction is performed at relatively low speed until the first hook 114 abuts against the distal end position of the article 200A and the second hook 115 abuts against the distal end position of the article 200B, and is performed at high speed after the first hook 114 and the second hook 115 respectively abut against the distal end positions of the articles 200A and 200B. Thus, damage to the articles 200A and 200B is prevented while the transfer process of the articles 200A and 200B is performed at high speed.

In the example shown in FIG. 13, it is assumed that there are sufficient distances between the first hook 114 and the distal end position of the article 200A and between the second hook 115 and the distal end position of the article 200B in the state when the slide arm 110 is moved to slide to the predetermined position on the shelf 302 side. Therefore, there is described below a case where the slide arm 110 moves at high speed when starting the movement, the movement speed of the slide arm 110 is decreased when the first hook 114 and the second hook 115 become close respectively to the distal end positions of the articles 200A and 200B, and further the movement is performed at high speed after the first hook 114 and the second hook 115 respectively reach the distal end positions of the articles 200A and 200B.

As shown in FIG. 13, the controller 400 transmits a control signal to the slide arm actuator 402 at time point T31 so as to start the slide movement of the slide arm 110 in the opposite direction. In this case, the movement speed of the slide arm 110 driven by the slide arm actuator 402 increases so as to reach the highest speed at time point T32.

When the controller 400 determines that the first hook 114 and the second hook 115 become close respectively to the distal end positions of the articles 200A and 200B, the controller 400 transmits a control signal to the slide arm actuator 402 so that the movement speed of the slide arm 110 is decreased. In FIG. 13, determining that distances between the positions of the first hook 114 and the second hook 115 and the distal end positions of the articles 200A and 200B become a predetermined value or smaller at time point T33, the controller 400 transmits a control signal to the slide arm actuator 402 so as to start the movement speed of the slide arm 110.

When the movement speed of the slide arm 110 reaches the predetermined value, the controller 400 controls the slide arm actuator 402 to maintain the movement speed. After that, the controller 400 controls to maintain the speed of the slide arm 110 until the first hook 114 and the second hook 115 respectively reach the distal end positions of the articles 200A and 200B.

In FIG. 13, the movement speed of the slide arm 110 reaches the predetermined value at time point T34, and after that the controller 400 maintains the movement speed of the slide arm 110 at the predetermined value of low speed until time point T36 when the second hook 115 reaches the end position of the article 200B.

In this case, the first hook 114 abuts against the distal end position of the article 200A at low speed at the time point T34, and after that the article 200A is transported at low speed until the time point T36 when the second hook 115 reaches the distal end position of the article 200B.

The movement speed of the slide arm 110 when it is decreased is set to such a degree that damage to the articles 200A and 200B is prevented when the first hook 114 and the second hook 115 respectively abut against the distal end positions of the articles 200A and 200B.

If it is determined that the first hook 114 and the second hook 115 have respectively reached the distal end positions of the articles 200A and 200B, the controller 400 starts to increase the movement speed of the slide arm 110.

If the first hook 114 and the first end detection sensor 116 are attached to the same or substantially same position in the moving direction of the slide arm 110, the controller 400 determines that the first hook 114 has reached the distal end position of the article 200A at time point T35 when the first end detection sensor 116 changes from the first state to the second state.

Similarly, if the second hook 115 and the third end detection sensor 119 are attached to the substantially same position in the moving direction of the slide arm 110, the controller 400 determines that the second hook 115 has reached the distal end position of the article 200B at the time point T36 when the third end detection sensor 119 changes from the first state to the second state.

In addition, when moving the slide arm 110 to slide toward the shelf 302, the controller 400 specifies the end positions of the articles 200A and 200B based on the detection signal of the first end detection sensor 116, and store the detected positions in a predetermined storage area. In this case, the controller 400 determines whether or not the first hook 114 and the second hook 115 have respectively reached the stored distal end positions of the articles 200A and 200B in accordance with the movement amount of the slide arm 110. For instance, if the slide arm actuator 402 includes a stepping motor with a servo mechanism, the controller 400 determines whether or not the first hook 114 and the second hook 115 have respectively reached the stored distal end positions of the articles 200A and 200B based on the number of drive pulses.

The controller 400 starts to increase the movement speed of the slide arm 110 at the time point T36. In this case, the movement speed of the slide arm 110 driven by the slide arm actuator 402 increases so as to reach the highest speed at time point T37.

When the movement speed of the slide arm 110 reaches the highest speed, the controller 400 controls to maintain the movement speed. As shown in FIG. 13, if it is determined that the speed of the slide arm 110 has reached the predetermined value at the time point T37, the controller 400 controls to maintain the speed of the slide arm 110 until time point T38 when starting to decrease the movement speed of the slide arm 110.

The controller 400 decreases the movement speed of the slide arm 110 so that the articles 200A and 200B stop at the transfer position on the elevation table 316 and stops the slide arm 110 at time point T39.

Also in the second preferred embodiment described above, similarly to the first preferred embodiment, it is possible to decrease the movement speed of the slide arm 110 when the first hook 114 and the second hook 115 abut against the articles 200A and 200B.

In addition, it is possible to configure the hook actuator 403 to include individual structures configured to move the first hook 114 and to move the second hook 115 between the action position and the retract position. In this case, it is possible to start the movement from the retract position to the action position when detecting the distal end positions of the articles 200A and 200B to be respectively transferred.

### Other Preferred Embodiments

Although various preferred embodiments of the present invention are described above, the present invention is not limited to the preferred embodiments described above and can be variously modified within the scope not deviating from the spirit of the present invention. In particular, the plurality of preferred embodiments and variations described in this specification can be arbitrarily combined as necessary.

Also in the case where three or more articles 200 placed in series in the moving direction of the slide arm 110 are simultaneously handled, the same structure can be adopted. However, it is necessary to provide the slide arm 110 with the hooks and the end detection sensors in accordance with the numbers of the articles 200 to be transferred.

The hook and the corresponding end detector may be disposed separately in the sliding direction of the slide arm.

In each of the preferred embodiments described above, preferably the controller (for example, the controller 400) commonly performs the three control operations as follows.
The controller sets the engagement member (for example, the first hook 114, the third hook 118) in the retract position (for example, Step S601, Step S1101), and starts to move the slide arm (for example, the slide arm 110) to slide until the engagement member becomes the predetermined position over the distal end position of the article (for example, the article 200, the article 200A) (for example, Step S602, Step S1102).
When the end detector (for example, the first end detection sensor 116, the third end detection sensor 119) detects the distal end position of the article (for example, Yes in Step S603, Step S1104), the controller starts to move the engagement member from the retract position to the action position (for example, Step S604, Step S1105).
After the engagement member reaches the predetermined position (for example, YES in Step S605, Step S1106), the controller moves the slide arm to slide in the opposite direction (for example, Step S607, Step S1108).

In this transfer device, the slide arm is moved to the predetermined position. In other words, the stroke thereof is set to be constant. Therefore, the slide arm is easily controlled. In addition, because the movement of the engagement member from the retract position to the action position is capable of being started when the end detector detects the distal end position of the article, the movement of the engagement member to the action position is performed during the sliding operation of the slide arm (for example, Step S604 to Yes in Step S605, Step S1105 to Yes in Step S1106). As a result, the transfer process time is significantly shortened.

Various preferred embodiments of the present invention may be applied to a transfer device configured to transfer an article in a stacker crane of an automatic warehouse or a station of an automated transport system.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-18. (canceled)

19. A transfer device comprising:
a slide arm capable of sliding relative to a placed article;
an engagement member attached to the slide arm and configured to move between an action position protruding toward the article in a direction crossing a sliding direction of the slide arm and a retract position to avoid contact with the article;
an end detector attached to the slide arm and configured to detect an end position of the article in the sliding direction of the slide arm; and
a controller configured or programmed to allow the engagement member to be placed in the retract position, allow the slide arm to start to slide to a predetermined position where the engagement member moves over a distal end position of the article, allow the engagement member to start to move from the retract position to the action position by determining that the engagement member has passed the distal end position of the article when the end detector detects the distal end position of the article during when the slide arm is moving to slide, and allow the slide arm to slide in the opposite direction after the engagement member reaches the predetermined position.

20. The transfer device according to claim 19, wherein the end detector is attached to the slide arm so as to be close to the engagement member.

21. The transfer device according to claim 19, wherein
the slide arm includes a pair of parallel arm portions positioned away from each other by a predetermined distance at positions capable of sliding on both sides of the article; and
the engagement member includes a pair of engagement portions provided respectively in the pair of arm portions.

22. The transfer device according to claim 20, wherein
the slide arm includes a pair of parallel arm portions positioned away from each other by a predetermined distance at positions capable of sliding on both sides of the article; and
the engagement member includes a pair of engagement portions provided respectively in the pair of arm portions.

23. The transfer device according to claim 21, wherein the end detector includes a light emitter and a light receiver provided respectively in the pair of arm portions.

24. The transfer device according to claim 22, wherein the end detector includes a light emitter and a light receiver provided respectively in the pair of arm portions.

25. The transfer device according to claim 19, wherein the controller is configured or programmed to store the distal end position of the article detected by the end detector when moving the slide arm until the engagement member reaches the predetermined position, and allow the slide arm to move slowly until the engagement member reaches the distal end position of the article at earliest when allowing the slide arm to slide in the opposite direction.

26. The transfer device according to claim 20, wherein the controller is configured or programmed to store the distal end position of the article detected by the end detector when moving the slide arm until the engagement member reaches the predetermined position, and allow the slide arm to move slowly until the engagement member reaches the distal end position of the article at earliest when allowing the slide arm to slide in the opposite direction.

27. The transfer device according to claim 21, wherein the controller is configured or programmed to store the distal end position of the article detected by the end detector when moving the slide arm until the engagement member reaches the predetermined position, and allow the slide arm to move slowly until the engagement member reaches the distal end position of the article at earliest when allowing the slide arm to slide in the opposite direction.

28. A transfer device comprising:
a slide arm capable of moving to slide relative to a first article and a second article placed in series in a moving direction;
a first engagement member and a second engagement member attached to the slide arm so as to correspond respectively to the first article and the second article, the first engagement member and the second engagement member being capable of moving synchronously with each other between an action position protruding toward the first article and the second article in a direction crossing a sliding direction of the slide arm and a retract position to avoid contact with the first article and the second article;
a first end detector and a second end detector attached to the slide arm, so as to respectively detect end positions of the first article and the second article in the sliding direction of the slide arm;
a controller configured or programmed to set the first engagement member and the second engagement member in the retract position, allow the slide arm to start to slide until the first engagement member and the second engagement member respectively reach a first position and a second position over distal end positions of the first article and the second article, allow the first engagement member and the second engagement member to start to move from the retract position to the action position by determining that the first engagement member and the second engagement member have respectively passed the distal end positions of the first article and the second article when the first end detector and the second end detector respectively detect the distal end positions of the first article and the second article during when the slide arm is moving to slide, and allow the slide arm to slide in the opposite direction after the first engagement member and the second engagement member respectively reach the first position and the second position.

29. The transfer device according to claim 28, wherein the first end detector and the second end detector are attached to the slide arm so as to be close to the first engagement member and the second end detector, respectively.

30. The transfer device according to claim 28, wherein
the slide arm includes a pair of parallel arm portions positioned away from each other by a predetermined distance at positions capable of sliding on both sides of the first article and the second article;
the first engagement member includes a pair of first engagement portions provided respectively in the pair of arm portions; and
the second engagement member includes a pair of second engagement portions provided respectively in the pair of arm portions.

31. The transfer device according to claim 29, wherein
the slide arm includes a pair of parallel arm portions positioned away from each other by a predetermined distance at positions capable of sliding on both sides of the first article and the second article;
the first engagement member includes a pair of first engagement portions provided respectively in the pair of arm portions; and
the second engagement member includes a pair of second engagement portions provided respectively in the pair of arm portions.

32. The transfer device according to claim 30, wherein each of the first end detector and the second end detector includes a light emitter and a light receiver provided respectively in the pair of arm portions.

33. The transfer device according to claim 31, wherein each of the first end detector and the second end detector includes a light emitter and a light receiver provided respectively in the pair of arm portions.

34. The transfer device according to claim 28, wherein the controller is configured or programmed to store the distal end position of the first article detected by the first end detector and the distal end position of the second article detected by the second end detector when moving the slide arm until the first engagement member reaches the first position and the second engagement member reaches the second position, and allow the slide arm to move slowly until the first engagement member reaches the distal end position of the first article and the second engagement member reaches the distal end position of the second article at earliest when allowing the slide arm to slide in the opposite direction.

35. The transfer device according to claim 29, wherein the controller is configured or programmed to store the distal end position of the first article detected by the first end detector and the distal end position of the second article detected by the second end detector when moving the slide arm until the first engagement member reaches the first position and the second engagement member reaches the second position, and allow the slide arm to move slowly until the first engagement member reaches the distal end position of the first article and the second engagement member reaches the distal end position of the second article at earliest when allowing the slide arm to slide in the opposite direction.

36. The transfer device according to claim 30, wherein the controller is configured or programmed to store the distal end position of the first article detected by the first end detector and the distal end position of the second article detected by the second end detector when moving the slide arm until the first engagement member reaches the first position and the second engagement member reaches the second position, and allow the slide arm to move slowly until the first engagement member reaches the distal end position of the first article and the second engagement member reaches the distal end position of the second article at earliest when allowing the slide arm to slide in the opposite direction.
